(19) United States
(12) Patent Application Publication
(10) Pub. No.: US 2023/0380621 A1
(43) Pub. Date: Nov. 30, 2023

(54) APPARATUS FOR PREPARING A BEVERAGE

(71) Applicant: Viktor Kaptelinin, Hornefors (SE)

(72) Inventor: Viktor Kaptelinin, Hornefors (SE)

(21) Appl. No.: 18/203,229

(22) Filed: May 30, 2023

Related U.S. Application Data
(63) Continuation-in-part of application No. 16/892,841, filed on Jun. 4, 2020, now abandoned.
(60) Provisional application No. 62/857,140, filed on Jun. 4, 2019.

(51) Int. Cl. A47J 31/20; A47J 31/06; A47J 31/44

(52) U.S. Cl. CPC A47J 31/20; A47J 31/0615; A47J 31/0636; A47J 31/4482

(57) ABSTRACT

An apparatus is provided for making beverages by immersing an infusible material, such as loose tea-leaves, in a liquid, such as hot water. The apparatus comprises two rigid-frame containers, a liquid-impermeable open-top beverage container, which can be an existing container selected by the user, and a movable liquid-permeable infuser container. According to embodiments of the invention, the infuser container may assume two different stationary positions relative to the beverage container, a lower stationary position and a higher stationary position. In the lower stationary position, the infusible material is covered by liquid and may be infused for a desired length of time. Thereafter the infuser container may be temporarily placed in the higher stationary position, in which position the infusible material is located above the liquid, to reduce or stop the dripping of the infusible material.

### CROSS-REFERENCE TO RELATED APPLICATIONS

The present application is a continuation-in-part of

U.S. patent application Ser. No. 16/892,841, filed Jun. 4, 2020, with title “APPARATUS AND METHOD FOR PREPARING A BEVERAGE” and naming Viktor Kaptelinin as inventor, which claims the benefit of provisional U.S. Patent Application Ser. No. 62/857,140, filed Jun. 4, 2019 with title “APPARATUS FOR PREPARING A BEVERAGE” and naming Viktor Kaptelinin as inventor. All of the foregoing applications are hereby incorporated herein by reference in their entirety.

### FEDERALLY SPONSORED RESEARCH

Not Applicable

### FIELD

The invention generally relates to the field of making a beverage, such as tea, herbal tea, or coffee, by infusing contents, such as tea-leaves, herbs, or ground coffee beans, in liquids. More specifically, it relates to beverage making devices comprising infusers or filters being immersed in liquids.

### BACKGROUND

A common way of making beverages, such as tea or coffee, is infusing an infusible material in liquid. The infusion process may be also referred to as “steeping”, “extracting”, or “brewing”. Infusible materials commonly used for making beverages include dried tea-leaves, herbs, dried berries, ground coffee, and so forth. The most commonly used liquid is hot water, but other liquids, such as milk, can also be used.

One type of infuser devices, known in prior art, are devices that comprise two essential parts, a stationary open top beverage container and a movable infuser container. Additional parts, such as lids, handles, nozzles, and so forth, may be added for convenience, safety, efficiency, or decorative purposes. Such infuser devices are easy to manufacture, learn, operate, and clean. However, liquid may drip from an infuser container for a relatively prolonged period of time after it is removed from the beverage container. The user faces the dilemma of either (a) manually holding the infuser container over the beverage container and waiting for the dripping to end, and thus wasting their time, or (b) removing the infuser container while the liquid is still dripping, and thus causing stains and wasting potentially valuable beverage.

Therefore, a limitation of prior art is that it does not teach beverage-making infusing devices, which are easy to operate and clean, and, at the same time, offer a solution to the problem of a prolonged dripping of infusible material.

### SUMMARY OF THE INVENTION

An infuser-type apparatus for preparing beverages is provided, with the aim of helping the user to deal with the problem of a prolonged dripping of an infusible material, which dripping takes place when an infuser, along with used infusible material, is removed from liquid. The apparatus comprises a stationary open-top liquid-impermeable beverage container and a movable infuser container. Each of the containers comprises a bottom and walls. The detachable infuser container is being liquid-permeable whereas impermeable to the infusible material. The apparatus is configured to enable a substantially direct insertion of the infuser container into the beverage container through a top opening of the beverage container by performing a substantially straight (i.e., linear) downward vertical movement of the infuser container. Similarly, the apparatus is configured to enable a substantially direct extraction (removal) of the infuser container from the beverage container by performing a substantially straight (i.e., linear) upward vertical movement of the infuser container. The infuser container is also configured to enable rotation of the container along a generally vertical axis.

The beverage container and the infuser container are configured to permit the infuser container, received within the beverage container, to assume one of two stationary positions relative to the beverage container, a lower stationary position and a higher stationary position. In the lower stationary position, the infuser container is inserted further into the beverage container than in the higher stationary position. Thus, in the lower stationary position an infusible material contained in the infuser container may be immersed in a liquid while in in the higher stationary position the infusible material may be placed above the liquid.

The particular position assumed by the infuser container, that is, the lower stationary position or the higher stationary position, is determined by the spatial orientation of the infuser container relative to the beverage container when the infuser container is being inserted into the beverage container. If the infuser container, when the infuser container is being lowered into the beverage container, is in one of the first plurality of spatial orientations relative to the beverage container, the infuser container assumes the lower stationary position. If the infuser container is in one of the second plurality of spatial orientations relative to the beverage container when it is being lowered into the beverage container, the infuser container assumes the higher stationary position. In each of the stationary positions the infuser container, after being inserted, rests on the beverage container and is stably supported by the beverage container. The apparatus is adapted to provide means (protrusions or recesses) preventing the infuser container from sliding sideways when being in the higher stationary position.

According to the first embodiment of the invention, a beverage container and an infuser container are adapted to permit a section of the beverage container to receive a section of the infuser container when the infuser container is in one of the first plurality of spatial orientations because in that orientation all horizontal dimensions of the infuser container section are smaller than internal horizontal dimensions of the beverage container section. Therefore, when the infuser container in one of the first plurality of spatial orientations is moved downwards, the infuser container section is fully inserted in the beverage container section and assumes the lower stationary position. The beverage container and the infuser container are also adapted not to permit the section of the beverage container to receive the section of the infuser container when the infuser container is in one of the second plurality of spatial orientations, because in that second spatial orientation some horizontal dimensions of the infuser container section are larger than internal horizontal dimensions of the beverage container section. Therefore, when the infuser container in one of the second plurality of spatial orientations is moved downwards, the infuser container section cannot be inserted in the beverage container section; instead it eventually presses against the beverage container section and assumes a higher stationary position. Consequently, in one of the first plurality of spatial orientations the infuser container is capable of being inserted in the beverage container for a longer distance (and assumes a lower stationary position) than in one of the second plurality of spatial orientations (and assumes a second higher stationary position).

According to the second embodiment of the invention, the infuser container comprises at least an extension element being connected to a top part of the infuser container and extending downward outside the beverage container, substantially along external walls of the beverage container. The external walls of the beverage container comprise a first at least a matching externally protruding element.

In one of the first plurality of spatial orientations of the infuser container the extension elements are not vertically aligned with matching protruding elements. Therefore, when the infuser container is being downwardly inserted in the beverage container, the extension elements move down unobstructed. In one of the second plurality of spatial orientations of the infuser container the extension elements are vertically aligned with the matching protruding elements. Therefore, when the infuser container is being downwardly inserted in the beverage container, the extension elements contact the protrusion elements and meet resistance from the protrusion elements. Consequently, the distance, for which the infuser container in one of the first plurality of spatial orientations can be inserted through the top opening of the beverage container before assuming a first stationary position is longer that the distance for which the infuser container in one of the second plurality of spatial orientations can be inserted through the top opening of the beverage container before assuming a second stationary position.

### DRAWINGS

FIGS. 1a-1j: show an apparatus according to the first embodiment of the present invention.

FIGS. 2a-2b: show a variation of the first embodiment of the present invention with a long infuser container.

FIG. 3: shows a top view of a variation of the first embodiment of the present invention with two ellipses intersecting at a focus of one of the ellipses.

FIGS. 4a-4b: show a variation of the first embodiment of the present invention having a generally triangular shape.

FIGS. 5a-5f: show a variation of the first embodiment of the present invention comprising an elevated circumferential wall.

FIGS. 6a-6c: show a variation of the first embodiment of the present invention comprising a cover connected to an open-top receptacle.

FIG. 7: shows a device according to the present invention comprising various additional elements.

FIGS. 8a-8h: show the second embodiment of the present invention comprising an infuser container comprising side protrusions.

FIGS. 9a-9b: show a variation of the first embodiment of the present invention with an adaptable supporting base.

FIGS. 10a-10c: show a further variation of the first embodiment of the present invention with an adaptable supporting base.

### DETAILED DESCRIPTION OF THE INVENTION

### General Remarks

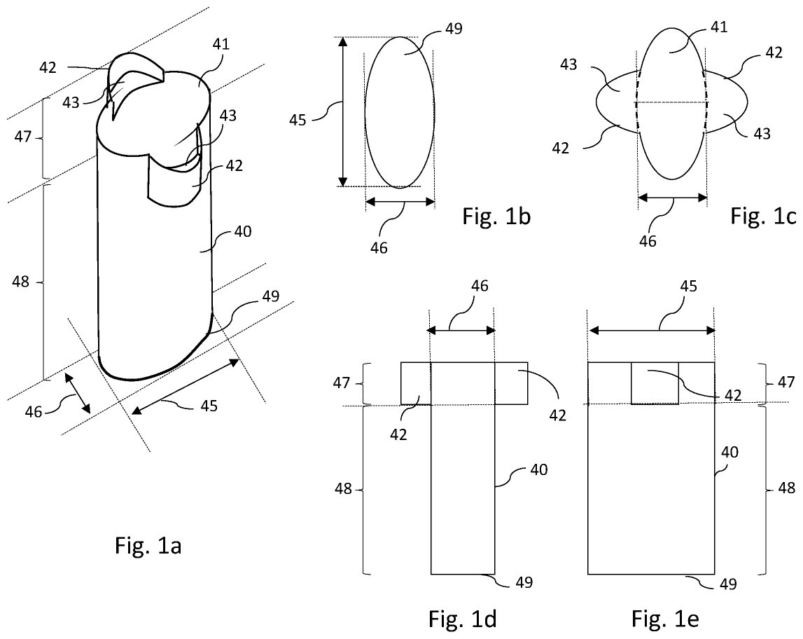

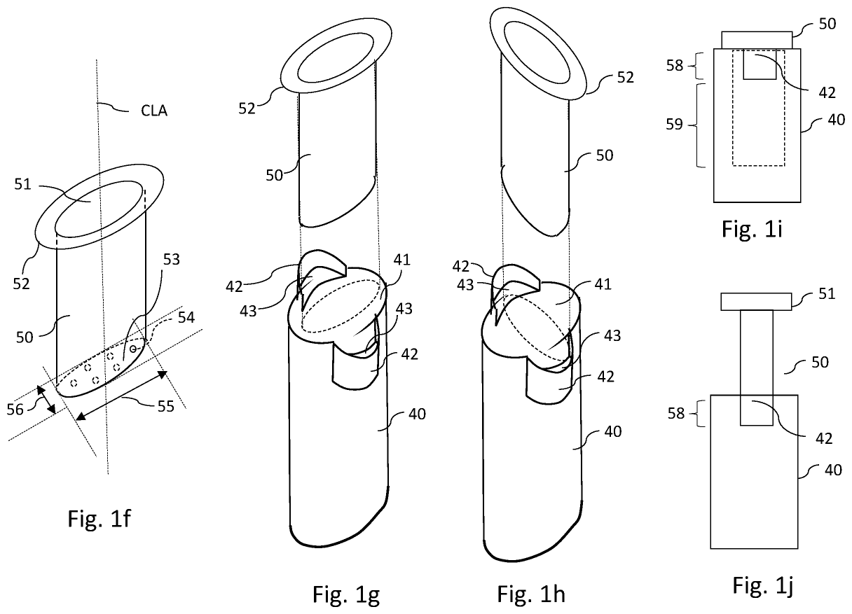

FIGS. 1-10 illustrate two preferred embodiments of the invention. Each embodiment is related to making beverages by immersing an infusible material in a liquid. The infusible material used to prepare a beverage may include, for instance, tea-leaves, ground coffee beans, or various herbs and berries. The liquid used the preparation of a beverage may be, for instance, hot water, cold water, hot milk, alcohol solution, and so forth.

Each of the embodiments illustrated by FIGS. 1-10 comprises at least two containers. The first container is a liquid-impermeable beverage container, in which the desired beverage is prepared. The beverage container is a vessel, in which the infusible material, used in making the beverage, is immersed in a liquid to produce the beverage. The beverage container is substantially stationary: the user may not need to move the container when preparing the beverage. The container comprises a body, which body comprises a bottom, walls, and a top opening. The container has a rigid frame made of a hard material, and may be completely made of a hard material. Therefore, the container is capable of substantially keeping its shape under normal use conditions. When in use, the beverage container is typically in an upright position.

The second container is a detachable and movable infuser container, which may be inserted in beverage container through the top opening of the beverage container. The infuser container contains the infusible material. The infuser container comprises a body, which body comprises a bottom, walls, and a top opening (said top opening may be covered with an optional lid). The container has a rigid frame made of a hard material, and may be completely made of a hard material. Therefore, the container is capable of substantially keeping its shape under normal use conditions. The infuser container is impermeable to the infusible material: the construction of the infuser container prevents the infusible material from passing through the body of the infuser container. At the same time, at least a part of the body of the infuser container is adapted to be liquid-permeable, so that the liquid can pass through the body of the infuser container. The infuser containers may be configured to be liquid-permeable but impermeable to the infusible material by, for instance, providing small perforation holes, or employing metal mesh, plastic mesh, or fabrics in the construction of the container.

According to the embodiments described in FIGS. 1-10, the infuser container can be directly, through a substantially single linear downward movement, placed on the beverage container and possible inserted in the beverage container. When being moved in such a manner, the infuser container assumes a stationary position, in which position the infuser container is resting/sitting on the beverage container and being supported by the beverage container. In accordance with the present invention the infuser container can be placed in one of two different stationary positions, a lower stationary position, and a second higher stationary position. In the lower stationary position, the infuser container sits/rests on the beverage container and is at least partly inserted in the beverage container. In the higher stationary position, the infuser container is inserted less, or not inserted at all, in the beverage container, and the bottom of the infuser container is located higher than said bottom is located the lower stationary position. In each of these stationary positions the apparatus is stable under normal use conditions (e.g., the apparatus is placed on a substantially horizontal stable surface and the user does not apply excessive force when inserting the infuser container into the beverage container). The apparatus is adapted to provide means (such as protrusions or recesses) preventing the infuser container from sliding sideways when being in the higher stationary position. Therefore, when the infuser container assumes one of these two stationary positions, the whole apparatus is in a stable position and does not require user-actions to maintain the stable position.

According to the embodiments shown in FIGS. 1-10, said beverage container and said infuser container are configured to permit an infuser container, which is in one of the first plurality of spatial orientations relative to said beverage container, to be moved downward to the beverage container and assume said lower stationary position. According to the embodiments shown in FIGS. 1-10, in one of the first plurality of spatial orientations said top opening of said infuser container is being located above said bottom of said infuser container, and said bottom of said infuser container and said opening of said beverage container are substantially vertically aligned with each other. Said beverage container and said infuser container are also configured to permit an infuser container, which is in one of the second plurality of spatial orientations relative to said beverage container when the infuser container is being moved downward to be placed on the beverage container, to assume said higher stationary position.

Therefore, the embodiments described in this section teach an apparatus for making beverages by immersing an infusible material in a liquid, said apparatus comprising:
a substantially rigid-frame liquid-impermeable beverage container, said beverage container comprising a bottom and walls, said beverage container having an opening at a top part of said beverage container; and
a detachable infuser container having a rigid-frame body comprising a bottom and walls, wherein at least a part of said body being partly liquid-permeable, said liquid-permeable body being impermeable to said infusible material; and
wherein said beverage container and said infuser container are configured to permit placing said infuser container, substantially vertically oriented, in one of the first plurality of spatial orientations and moving said infuser container in said one of the first plurality of spatial orientations substantially vertically downward, so that said infuser container assumes a lower stationary position relative to said beverage container, in which lower stationary position said infuser container is being at least partly inserted in said beverage container through said top opening of said beverage container, and in which lower stationary position said infuser container sits on said beverage container and is supported by said beverage container; and

wherein said beverage container and said infuser container are configured to permit placing said infuser container, substantially vertically oriented, in one of the second plurality of spatial orientations and moving said infuser container in said one of the second plurality of spatial orientations substantially vertically downward, so that said infuser container assumes a higher stationary position relative to said beverage container, in which higher stationary position said infuser container sits on said beverage container and is supported by said beverage container; and wherein in said higher stationary position said bottom of said insert container is located higher than said bottom of said insert container is located in said lower stationary position; and

wherein one out of the first plurality of orientations can be transformed into one of the second plurality of orientations by rotating said infuser container about a central longitudinal axis of the infuser container; and

whereby the user, when placing said infuser container in said beverage container, may selectively place said infuser container in said lower stationary position by selecting one out of said first plurality of orientations of said infuser container, and may selectively place said infuser container in said higher stationary position by selecting one out of said second plurality of orientations of said infuser container, wherein in said lower stationary position said infusible material may be immersed in a liquid, and in said higher position said infusible content may be elevated above the liquid.

### First Embodiment—Description

FIG. 1 shows a device according to the first embodiment of the present invention. The device comprises beverage container 40, and infuser container 50. For simplicity, the walls of the containers are assumed to be thin; the walls are represented by single lines.

The liquid-impermeable open-top beverage container 40 (FIG. 1a-FIG. 1e) comprises two integrated sections: a lower section 48 and a higher section 47. Lower section 48 has an elliptical shape in a horizontal cross-section. Section 48 has bottom 49. An inside perimeter of a horizontal cross-section of lower section 48 is an ellipse having a major axis 45 and a minor axis 46 (FIG. 1b). Higher section 47 continues lower section 48 upwards and defines top opening 41. The wall of higher section 47 comprises two oppositely located recesses 42, which recesses protrude outwardly from, respectively, the front side and the back side of beverage container 40. Bottom parts of recesses 42 form ledges 43. Lower section 48 and higher section 47, comprising recesses 42, are connected to each other to make sure that the entire body of beverage container 40 is liquid-impermeable (e.g., watertight).

FIG. 1c shows a top view of opening 41. The shape of opening 41 is defined by a central orthogonal intersection of two equal ellipses, one of the ellipses being a horizontal cross-section of lower section 48 and the other ellipse being an ellipse defined by recesses 42. FIG. 1d and FIG. 1e show, respectively, a side view and a front view of beverage container 40.

Infuser container 50 (FIG. 1f) is an open-top container having top opening 51, bottom 53, and perforation holes 54. Annular flange 52 projects radially outwards from opening 51. The body of infuser container 50 has an elliptical shape in a horizontal cross section. The inside perimeter of a horizontal cross-section of container 50 has the shape of an ellipse having major axis 55 and minor axis 56.

The length of major axis 45 of beverage container 40 is greater than the length of major axis 55 of infuser container 50, and the length of minor axis 46 of beverage container 40 is greater than the length of minor axis 56 of infuser container 50, whereas the length of minor axis 46 of beverage container 40 is smaller than the length of major axis 55 of infuser container 50. Consequently, when infuser container 50 is rotated about its central longitudinal axis CLA so that major axis 45 is aligned with major axis 55, and minor axis 46 is aligned with minor axis 56, the outside perimeter of infuser container 50 is completely within the inside perimeters of both higher section 47 and lower section 48. When infuser container 50, in this first orientation, is lowered toward beverage container 40, infuser container 50 is inserted in both section 47 and section 48 of beverage container 40 (FIG. 1g). In total, container 50 is inserted in container 40 for a distance 58, said distance is equal to the vertical dimension of section 47, and further for an additional distance 59. Flange 52 of infuser container 50 rests on the rim of opening 41, and infuser container 50 assumes a substantially stable lower stationary position (FIG. 1i).

When infuser container 50 is rotated about its central longitudinal axis CLA at a rotation angle of 90 degrees, so that major axis 55 of the infuser container is aligned with minor axis 46 of the beverage container, the outside perimeter of infuser container 50 is completely within the inside perimeter of higher section 47, but not within the inside perimeter of lower section 48 (FIG. 1h). Therefore, infuser container 50 cannot be inserted into lower section 48 of beverage container 40. When infuser container 50, in this second orientation, is moved down toward beverage container 40, infuser container 50 is inserted in higher section 47 but not in lower section 48. Therefore, container 50 is only inserted in container 40 for distance 58. Being received within higher section 47 infuser container 50 occupies the space defined by recesses 42 and rests on ledges 43, which ledges provide support for bottom 53. When inserted into recesses 42, infuser container 50 assumes a substantially stable higher stationary position if the apparatus is placed on a substantially flat horizontal surface (FIG. 1j). Recesses 42 also serve as means preventing infuser container 50 from sliding sideways in case of minor imbalance.

The illustrations of the first embodiment presented in FIGS. 1f-1j show a first orientation of infuser container 50, which results in the lower stationary position of infuser container 50 (FIG. 1g, FIG. 1i) and a second orientation of infuser container 50, which results in the higher stationary position of infuser container 50 (FIG. 1h, FIG. 1j). It is understood that the lower stationary position of infuser container 50 may result from several functionally identical orientations of infuser container 50. If infuser container 50 shown in FIG. 1g is rotated about central longitudinal axis CLA (FIG. 1f) by a rotational angle of 180 degrees, that other orientation will also result in the lower stationary position of infuser container 50 shown in FIG. 1i. Similarly, if infuser container 50 shown in FIG. 1h is rotated about central longitudinal axis CLA (FIG. 1f) by a rotational angle of 180 degrees, that other orientation will also result in the higher stationary position of infuser container 50 shown in FIG. 1j.

Therefore, according to the first embodiment, one of the first plurality of orientations (causing placing the infuser container in a lower stationary position) is transformed into one of the second plurality of orientations (causing placing the infuser container in a higher stationary position) by rotating said infuser container about a central longitudinal axis of the infuser container; and outside perimeter of at least a section of the infuser container has dimensions, which are smaller than some dimensions of an inside perimeter of a section of the beverage container that receives said infuser container section but larger than some other dimensions of the inside perimeter of the receiving beverage container section; and

in each of the first plurality of orientations each dimension of the outside perimeter of said at least a section of the infuser container is aligned with a larger dimension of the inside perimeter of the receiving beverage container section, so that the outside perimeter of said infuser container section is completely within the inside perimeter of the receiving beverage container section; and

in each of the second plurality of orientations at least one dimension of the outside perimeter of said infuser container section is aligned with a smaller dimension of the inside perimeter of the receiving beverage container section, so that at least a part of the outside perimeter of said infuser container section extend beyond the inside perimeter of the receiving beverage container section;

whereby the insert section can be inserted in the beverage container in each of the first plurality of orientations of the infuser container, but cannot be inserted in each of the second plurality of orientations; and whereby the infuser container having one out of the second plurality of orientations can be inserted in the beverage container for a shorter distance than the infuser container having one out of the first plurality of orientations.

It is appreciated that beverage containers and infuser containers according to the present invention preferably have symmetrical shapes. Therefore, an infuser container may typically have several spatial orientations, all of which result in the infuser insert being placed in the lower stationary position. Similarly, an infuser container may typically have several spatial orientations, all of which result in the infuser insert being placed in the higher stationary position. For generality, different spatial orientations of an infuser container resulting in placing the infuser container in the lower stationary position will be thereafter referred to as “the first plurality of orientations”. Different spatial orientations of an infuser container resulting in placing the infuser container in the higher stationary position will be thereafter referred to as “the second plurality of orientations”.

In some cases, when a beverage container, an infuser container, or both, have an irregular asymmetric shape, there may be only one spatial orientation, rather than a plurality of orientations, corresponding to the lower stationary position, or only one spatial orientation, rather than a plurality of orientations, corresponding the higher stationary position. Such cases are also covered by the present invention. Therefore, “a plurality of spatial orientations” in the context of the present invention may be understood as “at least one spatial orientation, and possibly several spatial orientations”.

### First Embodiment—Operation

One method of using devices (or apparatuses) according to the first embodiment comprises the following steps:
a. placing the infuser container in one of a first plurality of orientations, in which orientations the outside perimeter of infuser container 50 is completely contained within the inside perimeter of section 48;
b. inserting infuser container 50 in beverage container 40 through a substantially vertical downward movement until infuser container assumes a lower stationary position;
c. placing infusible material, such as tea-leaves, to infuser container
d. pouring a liquid, such as hot water, to infuser container 50 until the liquid at least partly covers the infusible material; in both containers the liquid reaches the same level;
e. waiting for a first desired length of time;
f. lifting infuser container 50 through a substantially vertical upward movement over beverage container 40 and placing infuser container 50 in one of a second plurality of orientations, in which orientations the outside perimeter of infuser container 50 is completely contained within the inside perimeter of section 47 but not completely contained within the inside perimeter of section 48;
g. inserting infuser container 50 in beverage container 40 through a substantially vertical downward movement until infuser container assumes a higher stationary position, in which position is inserted in section 47, but not in section 48, of beverage container and in which bottom 53 of infuser container 50 is supported by ledges 43;
h. waiting for a second desired length of time while liquid from infuser container 50 drips to beverage container 40;
i. when the dripping stops or is sufficiently reduced, removing infuser container 50 from beverage container 40;
j. whereby a ready to use beverage, contained in beverage container is prepared without excessive dripping of infusible material after the material, contained in infuser container 50, is removed from beverage container 40.

An obvious modification of the method described above is placing infuser container 50 in beverage container 40, with the infusible material being already contained in container 50. Other modifications are also obvious to those skilled in the art. In all cases the liquid, infuser container, and infusible material are all placed in the beverage container, so that the infusible material, contained inside the infuser container, is immersed in the liquid. After infusing the material for a desired length of time, the user removes the infuser container with the user material inside. The beverage container now only contains a newly prepared, ready to use beverage.

### First Embodiment—Advantages and Ramifications

Devices according to the first embodiment have a number of advantages. While they provide a solution to the prolonged dripping problem, they are also simple, safe, an effective to use, as well as easy to learn, clean, and manufacture. They are essentially self-explanatory and the user does not need to learn how to use them. Operating such a device is quick and easy: the user simply grasps the infuser container and moves it down to insert it in the beverage container. The user also directly lifts the infuser container up to remove it from the beverage container. Little or no effort is needed to assemble or re-assemble the device. The devices are easy to clean. The parts comprising the devices have a rigid structure and may be implemented without moving elements, which makes it possible to produce such devices of only hard non-toxic materials, such as glass, porcelain, or metal. The device makes it easy to infuse the same infusible material several times, which is common when making tea according to the Chinese tradition. The device may provide ample space for the infusible material to float during the infusion process, which is known to positively affect the quality of some of the beverages made by infusion.

It is appreciated that the embodiment shown in FIG. 1 serves as an illustration of a more general subject matter, that is, adapting an infuser container and a beverage container so that the infuser container having some rotational orientations about its longitudinal axis (corresponding to a first plurality of orientations) is permitted to be inserted in a section of the beverage container, and the infuser container having some other rotational orientations about its longitudinal axis (corresponding to a second plurality of orientations) is not permitted to be inserted in said section of the beverage container. Various other modifications are obvious to the one skilled in the art and are covered by the present invention.

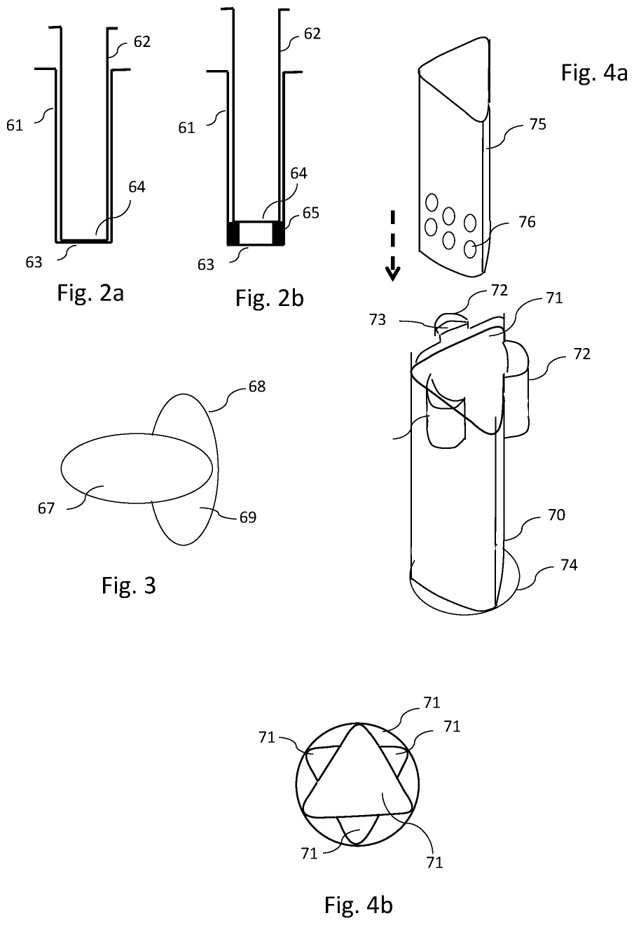

FIG. 1 shows a lower stationary position of insert container 50 (FIG. 1i), in which position infuser container 50 cannot be inserted more into beverage container 40 because a dimension of a top part of container 50 (namely, flange 52) exceeds a dimension of opening 51. Other ways of configuring a beverage container and an infuser container to provide stationary support for infuser container in the lower stationary position are obvious and are covered by the present invention. For instance, FIG. 2 shows infuser container 62 long enough to reach bottom 63 or narrowed lower part 65 of beverage container 61, and assume a stationary position, in which bottom 64 of infuser container 62 rests on bottom 63 or narrowed lower part 65 of beverage container 61, while the top of infuser container 62 is elevated above beverage container 61.

The inner contour of a top opening of a beverage container, can be defined by not only two ellipses intersected at their center points at 90 degrees, as shown in FIG. 1. The opening contour may, for instance, be defined by two ellipses intersected at various angles and at various points. FIG. 3 shows a top view of a beverage container according to the present invention, where two identical ellipses are orthogonally intersecting at a focus, instead of a center point, of one of the ellipses, to define beverage container opening 67, as well as recesses 68 forming ledges 69.

A device according to the present invention may employ various shapes other than the elliptical shape described in FIG. 1. A wide variety of two concentric shapes may be employed so that in some rotational orientations of an inner shape said inner shape is completely within the perimeter of an outer shape, while in in some other rotational orientations of an inner shape said inner shape is extends beyond the perimeter of the outer shape. It is it is obvious that the beverage container and the infuser container may be configured so that such concentric shapes are employed as (a) an inside perimeter of a horizontal cross-section of a section of a beverage container (the larger shape) and (b) an outside perimeter of at least a part of an infuser container (the smaller shape).

For instance, generally triangular or rectangular shapes, or diverse irregular shapes may be employed. FIG. 4 shows an example of a device employing a generally triangular shape with rounded corners for both a section of beverage container 70 (a larger shape) having top opening 71 and infuser container 75 (a smaller shape) having perforations 76. When infuser container 75 is rotated along a central longitudinal axis to have one of the first plurality of orientations, so that the sides of the concentric triangles are parallel to each other, infuser container 75 may be inserted in beverage container 70 to assume a lower stationary position. When infuser container 75 is rotated about the central vertical axis at 60, 180, 300, etc., degrees from said one out of the first plurality of orientations, infuser container 75 is placed in one out of the second plurality of orientations, in which orientation it may be inserted in recesses 72. When received within recesses 72, infuser container 75 rests on ledges 73 formed by recesses 72, assuming a higher stationary position.

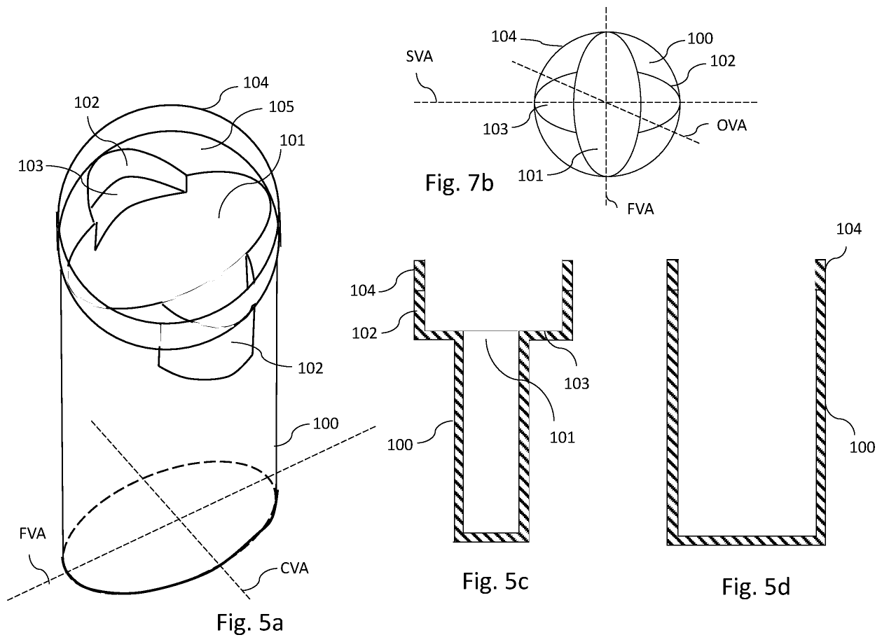

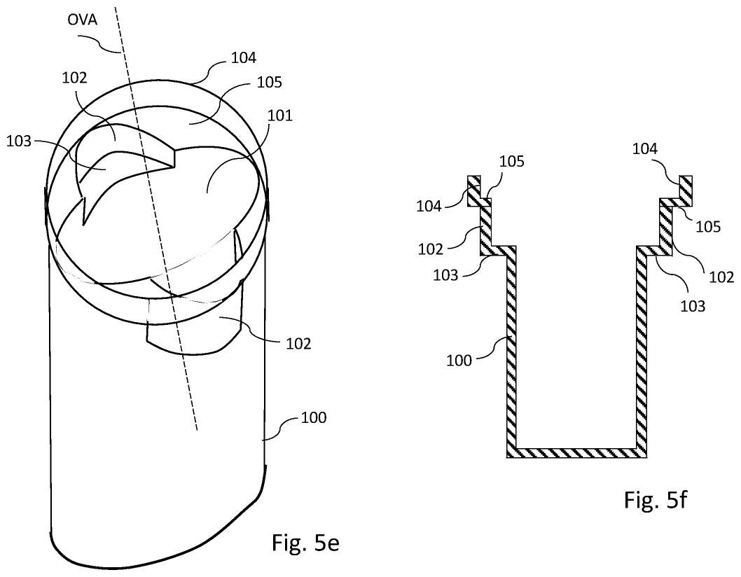

The device shown in FIG. 5 is a variation of the first embodiment depicted in FIG. 1. FIG. 5 shows beverage container 100, which comprises elevated circumferential watertight wall 104 surrounding opening 101, as well as horizontal watertight surface 105. Surface 105, consisting of four parts, fills spaces defined by opening 101, recesses 102, and wall 104. When lifted from liquid, infuser container is likely to drip, so wall 104 and surface 105 make sure the dripping liquid is not spilled outside beverage container 100. A combination of wall 104 and surface 105 provides means for preventing leakage and spilling of liquid outside beverage container 100 when the user moves the infuser container from a lower stationary position to a higher stationary position. Leakage-preventing means comprising wall 104 and surface 105 make it possible for the user to lift an infuser container from a lower stationary position (in which the infusible material is immersed in liquid) and place it in a higher stationary position (in which the infusible material is located above the liquid), while continuously keeping the infuser container partly inserted in beverage container 100. A top view of beverage container 100 shows a circle encircling opening 101, recesses 102, and ledges 103 (FIG. 5b). FIG. 5c and FIG. 5d show, respectively, a front cross section view (a vertical cross-cut defined by front view axis FVA) and a side cross-section view (a vertical cross-cut defined by side view axis SVA) of beverage container 100. A diagonal cross cut of beverage container 100, defined by axis OVA (FIG. 5b, FIG. 5e), is shown in FIG. 5f.

Therefore, according to the variation of the first embodiment, depicted in FIG. 5, the beverage container comprises an elevated wall member complemented with substantially horizontal members to collectively comprise leakage-preventing means, said leakage-preventing means configured to permit changing an orientation of said infuser container from one out of said first plurality of orientations to one out of said second plurality of orientations without completely removing said infuser container from said beverage container and thereby preventing a liquid dripping from said infuser container from spilling from said beverage container.

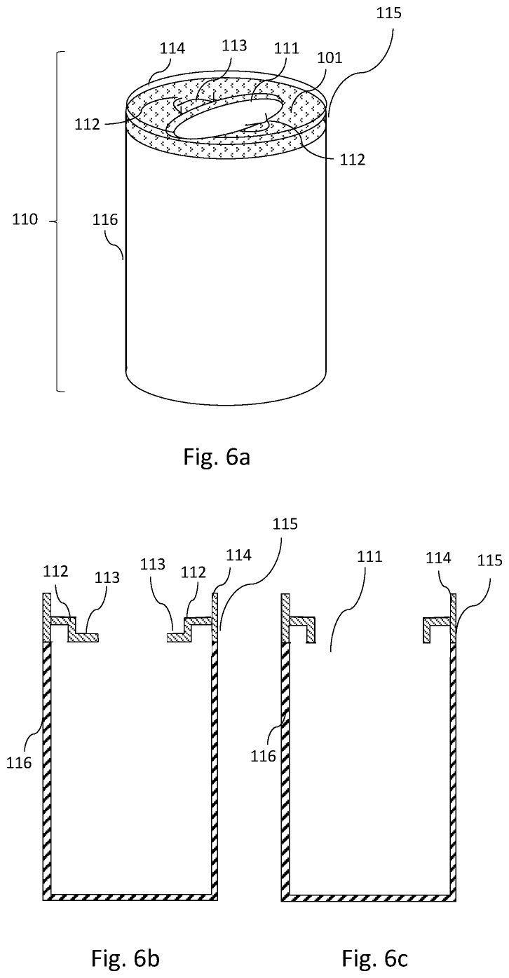

FIG. 6 shows beverage container 110 comprising cover 115 connected to cylindrical open-top receptacle 116. Employing cover 115 in combination with receptacle 116 illustrates a possibility to employ infuser containers similar to those depicted on FIG. 1 and FIG. 5, having receptacles of various shapes. The shape of cover 115 is similar to the shape of the top part of beverage container 100 shown in FIG. 5. Cover 115, like the top part of beverage container 100, has elliptical opening 111, two lateral recesses 112 forming ledges 113, and leakage-preventing means comprising wall 114 and surface 101. Surface 101 fills spaces between opening 111, recesses 112, and wall 114. Cover 115 may be an integral part of beverage container 100. Alternatively, cover 115 may be a detachable part, attached to receptacle 116, for instance, as a snap-on or a twist-on attachment. Cover 115 may be removed from receptacle 116 (e.g., by twisting off), for instance, for an easy cleaning of receptacle 116.

Various modifications of the embodiment shown in FIG. 6 are obvious to those skilled in the art. They include using covers and covers' parts of different sizes and shapes. Recesses, similar to recesses 112, can be of different sizes and shapes. The covers can be attached to receptacles of different shapes and sizes. Various ways of attaching a cover to a receptacle may be employed. All these modifications are covered by the present invention.

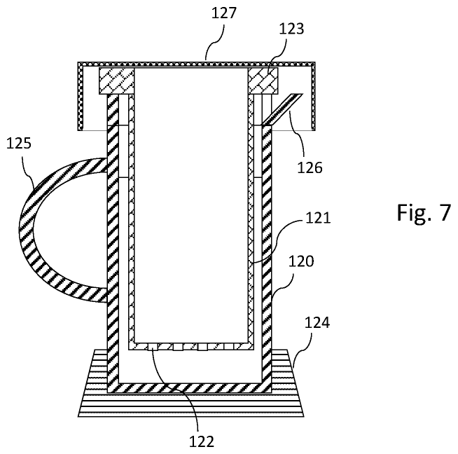

It is appreciated that a beverage-making device according to the present invention, either the entire device or its component parts, can be made of various materials, such as glass, metal, plastic, and so forth. As illustrated by FIG. 7, various additional elements can be added, such as lid 127, which can also be used as a tray for an infuser container 121 when infuser container 121 having perforations 122 and ledges 123, is removed from a beverage container 120. Other elements, such as handle 125, nozzles 126, support 124, or other types of lids, nozzles, handles, and supported, can also be used. The rims of openings of both cover 115 and infuser container can be reinforced, for instance, by providing a metal brim.

### Second Embodiment—Description and Operation

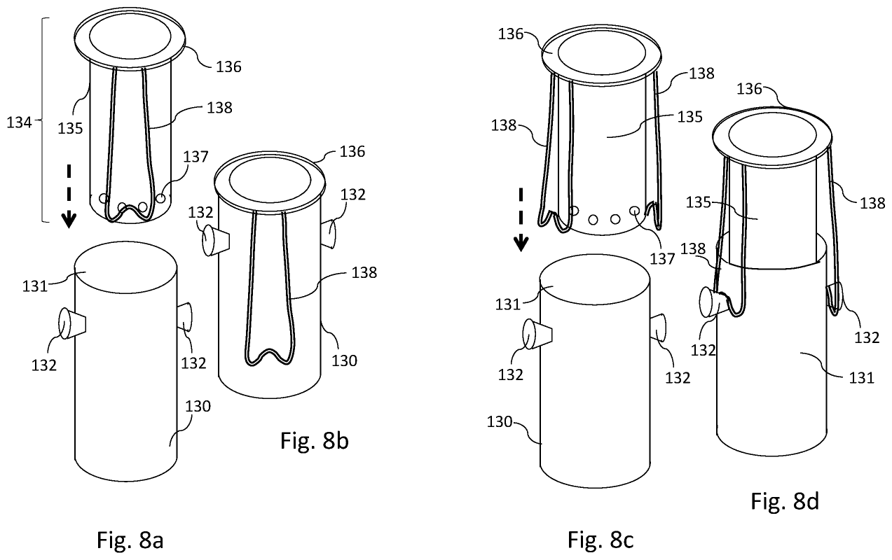

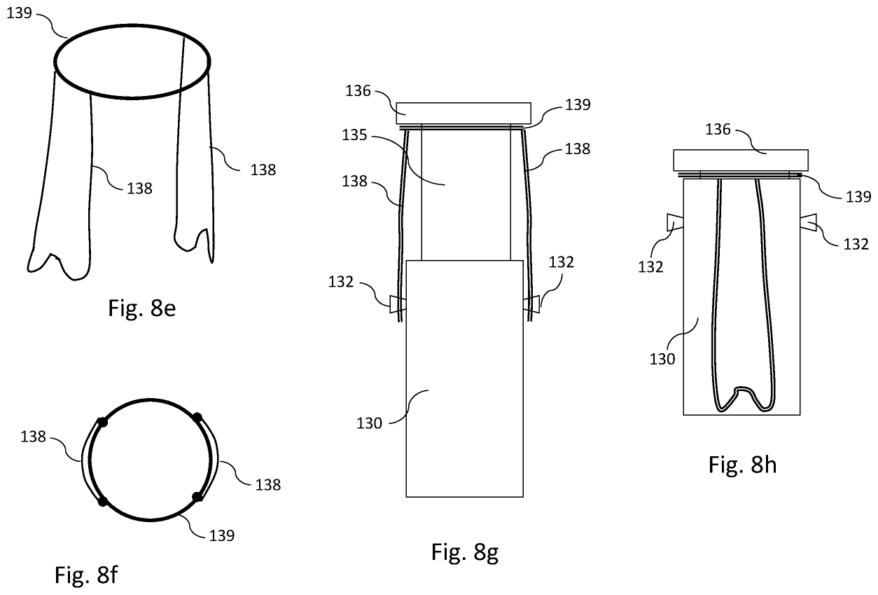

The second embodiment of the invention is shown in FIG. 8. According to the second embodiment a transition from one of the first plurality of orientations, in which an infuser container is placed in a lower stationary position relative to a beverage container, to one of the second plurality of orientations, in which an infuser container is placed in a higher stationary position, is achieved by rotating the infuser container relative to the beverage container about a central longitudinal axis of the infuser container. The infuser container according to the second embodiment, comprises a plurality of extension members connected to the infuser container and extending substantially downwards from a top part of the infuser container along external walls of the beverage container.

External walls of the beverage container comprise a plurality of external protruding elements, which plurality of protruding elements generally match the plurality of extension members. Placing a vertically oriented infuser container above the top opening of the beverage container and rotating the infuser container about a central longitudinal axis so that the infuser container assumes one out of the first plurality of orientations places the plurality of extension members in a position, in which the extension members may move down unobstructed when the infuser container is lowered. In this orientation lowering the infuser container places the infuser container in the lower stationary position, in which a receptacle part of the infuser container containing an infusible material is located inside the beverage container, and the extension members are located outside the beverage container. Thereby infuser container assumes a lower stationary position, in which position the infuser container is supported by the beverage container, and in which position the extension members do not meet resistance from the matching protrusion elements.

Rotating a vertically oriented infuser container about a central longitudinal axis so that it assumes one of the second plurality of orientations places the extension members in a position, from which the extension members may not move down unobstructed when the infuser container is lowered. The extension members contact the protruding elements, meet resistance from the protruding elements, and receive support from the external protruding elements, which prevents the infuser container from moving lower. The infuser container assumes a higher stationary position, in which position the infuser container rests of the beverage container and the extension members press against the protruding elements.

Therefore, the second embodiment teaches an apparatus for making beverages, wherein the infuser container comprises a plurality of extension elements connected to a top part of the infuser container and extending downward outside the beverage container; and

external walls of the beverage container comprise at least a first plurality of matching external protruding elements; and

in each of the first plurality of orientations of the infuser container the extension elements are not vertically aligned with the first plurality of matching protruding elements, and when the infuser container is being inserted in the beverage container the extension elements can move down unobstructed; and

in each of the second plurality of orientations of the infuser container the extension elements are vertically aligned with the first plurality of matching protruding elements, and, when the infuser container is being inserted in the beverage container, the extension elements press against said protrusion elements, meet resistance, and downward movement of said extension elements is obstructed;

whereby the infuser container having one out of the second plurality of orientations can be inserted in the beverage container for a shorter distance than the infuser container having one out of the first plurality of orientations.

A device according to the second embodiment is depicted in FIG. 8. The device comprises beverage container 130 and infuser container 134. Beverage container 130, having a substantially cylindrical shape, comprises top opening 131 and two external protrusions 132. External protrusions 132 are located at opposite sides of beverage container 130, protruding externally from external walls of beverage container 130. Protrusions 132 may be used as handles for operating beverage container 130. Infuser container 134 comprises substantially cylindrically shaped receptacle 135 containing the infusible material (not shown), flange 136, ring member 139 located underneath flange 136, and two extension members 138 connected to ring member 139. Receptacle 135 has perforation holes 137. Extension members 138, attached to ring member 139, extend outside receptacle 135 and beyond external walls of beverage container 130, substantially downwards. A smaller diameter of receptacle 135 compared to the diameter of beverage container 130 permits an insertion of receptacle 135 in beverage container 130 at all rotational orientations of infuser container 134 about a central longitudinal axis of container 134, since the outside perimeter of receptacle 135 is at all rotation angles is smaller than the inside perimeter of beverage container 130.

By adjusting a rotation angle of infuser container 134 about a central longitudinal vertical axis of infuser container 134 before placing infuser container 134 on beverage container 130, the user can selectively insert infuser container 134 deeper or less deep in beverage container 130, causing container 134 to assume, respectively, a lower stationary position or a higher stationary position. To choose the lower stationary position the user places infuser container 134 in upright position above opening 131 of beverage container 130 and rotates infuser container 134 so that extensions 138 are not vertically aligned with protrusions 138. When infuser container 134 in this orientation is moved down to beverage container 130, extensions 138 move down unobstructed, which permits a deeper insertion of infuser container 134 into beverage container 130. Infuser container 134 then assumes a lower stationary position (FIG. 8a, FIG. 8b, and FIG. 8h). To choose a higher stationary position the user places infuser container 134 in upright position above opening 131 of beverage container 130 and rotates infuser container 134 so that extensions 138 are vertically aligned with matching protrusions 132. When infuser container 134 in this orientation is moved down to beverage container 130, extensions 138 press against protrusions 132 and meet resistance from protrusions 132, which causes infuser container 134 stop moving further down into beverage container 130. Infuser container 134 assumes an elevated, higher stationary position, being only partly inserted in beverage container 130 (FIG. 8c, FIG. 8d, and FIG. 8g).

Therefore, according to the second embodiment, the first plurality of orientations is transformed into the second plurality of orientations by rotating the infuser container about a central longitudinal axis of the infuser container; and
a. the infuser container comprises a plurality of extension elements connected to the top part of the infuser container and extending downward outside the beverage container; and
b. external walls of the beverage container comprise at least a first a plurality of matching external protruding elements; and
c. in each of the first plurality of orientations of the infuser container the extension elements are not vertically aligned with the first plurality of matching protruding elements, and when the infuser container is being inserted in the beverage container the extension elements can move down unobstructed; and
d. in each of the second plurality of orientations of the infuser container the extension elements are vertically aligned with the first plurality of matching protruding elements, and, when the infuser container is being inserted in the beverage container, the extension elements press against said protrusion elements and meet resistance;

whereby the infuser container having one out of the second plurality of orientations can be inserted in the beverage container for a shorter distance than the infuser container having one out of the first plurality of orientations.

### Second Embodiment—Ramifications

The second embodiment has substantially the same advantages as the first embodiment. The embodiment illustrated by FIG. 8 is intended as an illustrative example. Numerous modifications of beverage making devices employing external extensions of immersible infusers combined with external protrusions of beverage containers are obvious to those skilled in the art. One such modification is a device comprising an infuser container, which is implemented so that the two main parts comprising the infuser container, a receptacle for infuser material and extension members, may move independently of each other. In particular, the extension members may be able to rotate about the central longitudinal axis of the infuser container while the receptacle may maintain the same rotational orientation.

Another obvious modification is a device according to the second embodiment, comprising an additional second plurality of protruding elements supporting the infuser container in a lower stationary position. The second plurality of protrusions may be located lower than protrusions supporting the infuser container in the higher stationary position (such as protrusions 132 shown in FIG. 8).

The infuser container may be configured to permit rotating the plurality of extension members independently from the rest of the infuser container. For instance, ring 139 with attached extension members 138, shown in FIG. 8 may be adapted to be capable of rotating under independently of receptacle 135, so that the user may change the orientation of infuser container from one of a first plurality of orientations to one of a second plurality of orientations without rotating receptacle 135.

### GENERAL REMARKS AND RAMIFICATIONS

Apparatuses according to the present invention can be used for preparing a wide variety of beverages, using various infusible materials (including black tea, green tea, white tea, rooibos tea, hibiscus tea, herbal tea, ground coffee, herbs, dried berries, and so forth) and various liquids.

Apparatuses according to the present invention can have various form factors and can be implemented as various products. For instance, they may or may not be implemented as electric kettles. They can be implemented as devices for personal use (e.g., serve as personal tea cups) or group use (i.e., devices shared by several uses). They can be made of various materials, for instance, glass, metal, porcelain, clay, plastic, as well as fabrics attached to a rigid frame, or of a combination of different materials.

Apparatuses according to the present invention can be combined with various additional elements, such as a lid, which may, for instance, serve as tray for the infuser container when the container is removed from the beverage container.

The terms “apparatus and “device” are used interchangeably in this document.

When beverage containers of the types described in FIG. 1-8 are in use, they are normally oriented upright, so that their openings are located substantially in their upper sections, facing up, to avoid spilling the liquid contained in the beverage container. This orientation is considered “vertical” in the context of the present disclosure, and other terms, such as, “horizontal”, “higher”, “lower”, “up”, and “down” are used here in relation to this (vertical) orientation of beverage containers. The use of the terms is limited to the purpose of illustrating the described embodiments of the invention. It is understood that the containers can be oriented so that the openings face virtually any direction, in particular, when parts of a device are being cleaned, stored, or assembled before adding liquid. The use of the terms, “vertical”, “lower”, “down” and so forth, therefore, does not limit the scope of the invention.

There may not be a clear border separating a container's walls and bottom, for instance, if a beverage container has a substantially semi-spherical shape (in which case the beverage container may be attached to a stand having a flat lower part and a concave upper part serving as a receptacle to beverage container's bottom, to ensure stability of the beverage container). In such cases the bottom of the container is generally the part of the container, which is located opposite to the top opening and represents a lower part of the beverage container during the normal use conditions. Defining an exact border between the walls and the bottom of a beverage container is not essential for the subject matter of the present invention.

A longitudinal axis in the context of the present invention is an axis, which is parallel to the top-bottom dimension of an infuser container or a beverage container. If not specially mentioned, both containers are oriented so that their top openings are located above, and are vertically aligned with, their bottoms.

The transition from one out of the first plurality of orientations (in which orientations the infuser container assumes the lower stationary position when being lowered on the beverage container) to one out of the second plurality of orientations (in which orientations the infuser container assumes the second higher stationary position when being lowered on the beverage container), according to the first and second embodiments of the present invention, is described above as being achieved by rotating the infuser container about its central longitudinal axis. It is obvious to those skilled in the art, that additional movements may be required in addition to changing the rotational orientation of an infuser container about a longitudinal axis before the infuser container is moved downward toward a beverage container. In general, to successfully perform a transition of an infuser container from one of the first plurality of orientations to one of the second plurality of orientations according to the first and second embodiments, the user does not need to accurately identify and use the central longitudinal axis of the infuser container. Such as transition can be achieved, for instance, by rotating the infuser container about any longitudinal axis and then adjusting the position of the infuser container by moving the container horizontally.

Furthermore, it is understood that the above difference between the first and second pluralities of orientations is described regarding the outcome, rather than the actual process, of the transition. When moving an infuser container from one of the first plurality of orientations to one of the second plurality of orientations the user may achieve the transition in several steps and by combining various types of movements. The process may also include trial and error.

Additionally, it is understood that the scope of the present invention extends to apparatuses, which do not include a particular beverage container; such apparatuses are adapted to be used in combination with a variety of vessels serving as beverage containers. In other words, consumer products implementing the invention may not include a beverage container; instead, they allow the user himself or herself to choose a beverage container for preparing a beverage. For instance, when manufactured or sold, such products may only include an infuser container or a combination of an infuser container and a supporting base. Such components are provided to be used in combination with a variety of vessels of the user's choosing, which vessels serve as beverage containers.

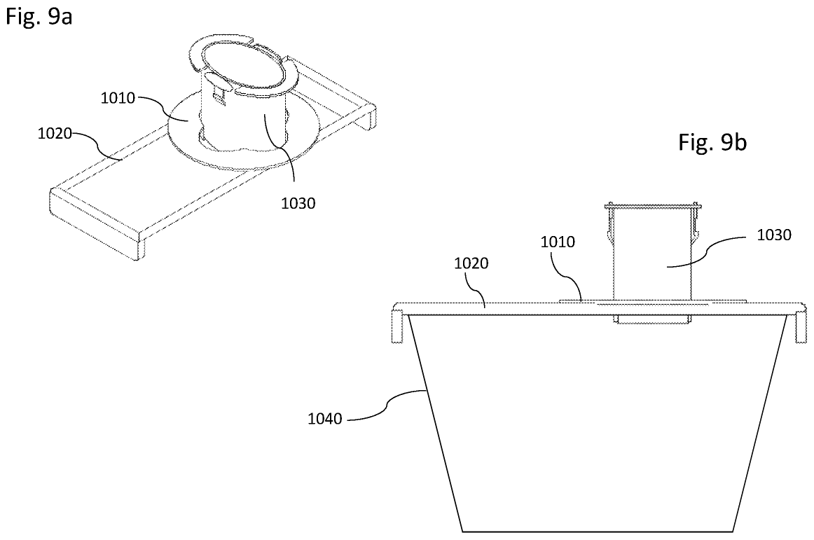

For instance, a product according to a variation of the first embodiment may comprise an infuser similar to infuser container 50 (see FIG. 1) and a supporting base similar to cover 115 (see FIG. 6). The supporting base, like cover 115, supports the infuser container in both higher stable position and lower stable position. The supporting base is adapted, using methods obvious to those skilled in the art, to allow its use in combination with a variety of containers of different shapes and sizes, such as cups, mugs, glasses, teapots, carafes, or kettles. A supporting base can have horizontal extensions, which extensions allow the supporting base to be supported by containers of various sizes and shapes in a stable position over top openings of said containers. A variation of such embodiment is illustrated in FIG. 9. It shows a supporting base being a physical object comprising two integrated components: holder 1010 and frame 1020 (FIGS. 9a, b). The components are made of a hard material, such as metal, and are permanently attached (e.g., glued or soldered) to each other, or the whole supporting base can be manufactured as one physical object. Holder 1010, similarly to cover 115 (FIG. 6), supports infuser container 1030 in both lower stable position (not shown) and higher stable position. Frame 1020 makes it possible to place the supporting base over container 1040 (e.g., a cup) serving as a beverage container (FIG. 9b). In the lower stable position (not shown) of infuser container 1030, infusible material, such tea leaves, contained in infuser container 1030, is submerged in the liquid contained in beverage container 1040. In the higher stable position of infuser 1030 the infusible material is located substantially above the liquid contained in beverage container 1040.

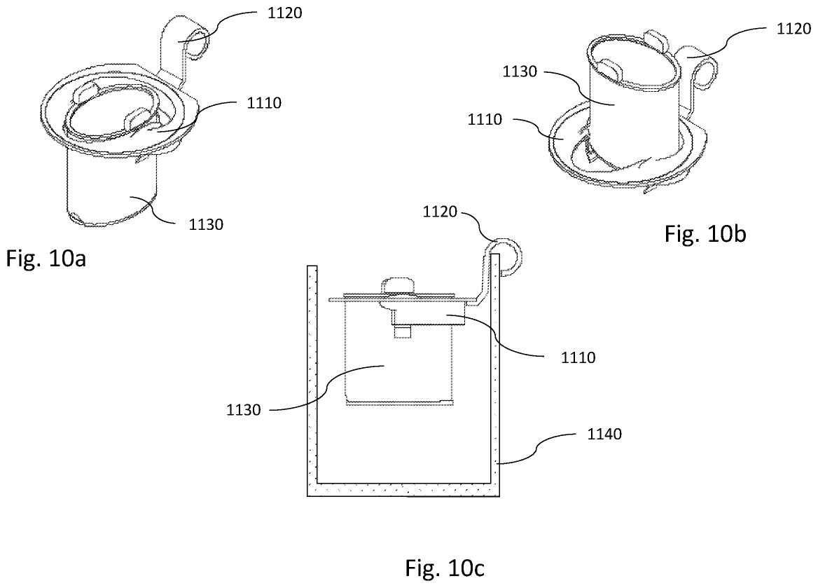

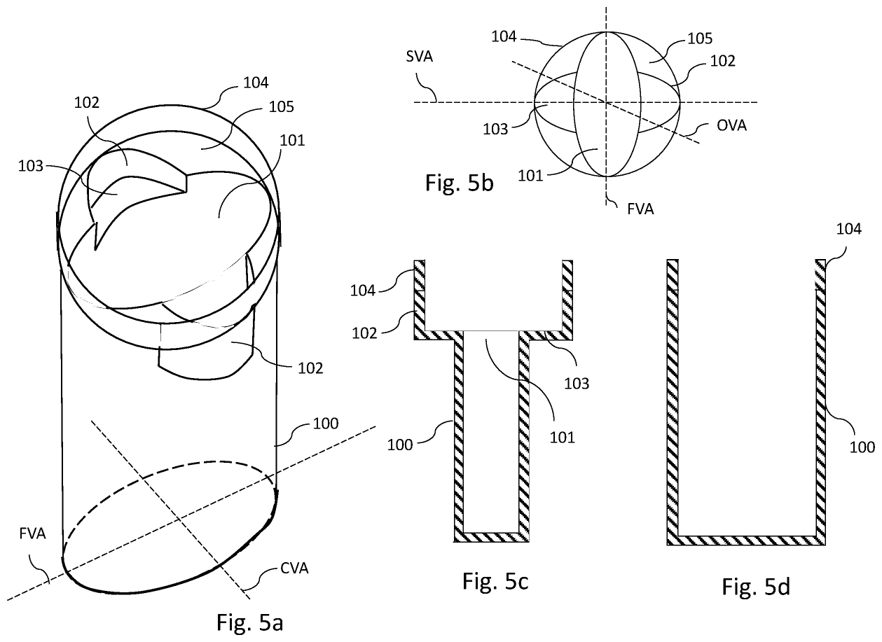

A variation of the above embodiment is shown in FIG. 10. According to the embodiment, holder 1110, which is similar to holder 1010, can support infuser container 1130 in a lower stable position and a higher stable position. Holder 1110 is integrated with handle 1120, which handle is engaged with the rim of a top opening of beverage container 1140, and thus may support holder 1110 in a stable position substantially relative to beverage container 1140.

All these embodiments are within the scope of the present invention.

1. An apparatus for making beverages by immersing an infusible material in a liquid, said apparatus comprising:
a substantially rigid-frame liquid-impermeable beverage container, said beverage container comprising a bottom and walls, said beverage container having an opening at a top part of said beverage container; and
a detachable infuser container having a rigid-frame body comprising a bottom and walls, wherein at least a part of said body being partly liquid-permeable, said liquid-permeable body being impermeable to said infusible material; and
wherein said beverage container and said infuser container are configured to permit placing said infuser container, substantially vertically oriented, in one of the first plurality of spatial orientations and moving said infuser container in said one of the first plurality of spatial orientations substantially vertically downward, so that said infuser container assumes a lower stationary position relative to said beverage container, in which lower stationary position said infuser container is being at least partly inserted in said beverage container through said top opening of said beverage container, and in which lower stationary position said infuser container sits on said beverage container and is supported by said beverage container; and
wherein said beverage container and said infuser container are configured to permit placing said infuser container, substantially vertically oriented, in one of the second plurality of spatial orientations and moving said infuser container in said one of the second plurality of spatial orientations substantially vertically downward, so that said infuser container assumes a higher stationary position relative to said beverage container, in which higher stationary position said infuser container sits on said beverage container and is supported by said beverage container; and wherein in said higher stationary position said bottom of said insert container is located higher than said bottom of said insert container is located in said lower stationary position; and
wherein one out of the first plurality of orientations can be transformed into one of the second plurality of orientations by rotating said infuser container about a central longitudinal axis of the infuser container; and
whereby the user, when placing said infuser container in said beverage container, may selectively place said infuser container in said lower stationary position by selecting one out of said first plurality of orientations of said infuser container, and may selectively place said infuser container in said higher stationary position by selecting one out of said second plurality of orientations of said infuser container, wherein in said lower stationary position said infusible material may be immersed in a liquid, and in said higher position said infusible content may be elevated above the liquid.

2. Apparatus of claim 1, wherein
an outside perimeter of at least a section of the infuser container has dimensions, which are smaller than some dimensions of an inside perimeter of a section of the beverage container that receives said infuser container section but larger than some other dimensions of the inside perimeter of the receiving beverage container section; and
in each of the first plurality of orientations each dimension of the outside perimeter of said at least a section of the infuser container is aligned with a larger dimension of the inside perimeter of the receiving beverage container section, so that the outside perimeter of said infuser container section is completely within the inside perimeter of the receiving beverage container section; and
in each of the second plurality of orientations at least one dimension of the outside perimeter of said infuser container section is aligned with a smaller dimension of the inside perimeter of the receiving beverage container section, so that at least a part of the outside perimeter of said infuser container section extend beyond the inside perimeter of the receiving beverage container section;
whereby said infuser container section can be inserted in the receiving beverage container section in each of the first plurality of orientations of the infuser container, but cannot be inserted in each of the second plurality of orientations; and whereby the infuser container having one out of the second plurality of orientations can be inserted in the beverage container for a shorter distance than the infuser container having one out of the first plurality of orientations.

3. Apparatus of claim 1, wherein
the infuser container comprises a plurality of extension elements connected to a top part of the infuser container and extending downward outside the beverage container; and
external walls of the beverage container comprise at least a first plurality of matching external protruding elements; and
in each of the first plurality of orientations of the infuser container the extension elements are not vertically aligned with the first plurality of matching protruding elements, and when the infuser container is being inserted in the beverage container the extension elements can move down unobstructed; and
in each of the second plurality of orientations of the infuser container the extension elements are vertically aligned with the first plurality of matching protruding elements, and, when the infuser container is being inserted in the beverage container, the extension elements press against said protrusion elements, meet resistance, and downward movement of said extension elements is obstructed;
whereby the infuser container having one out of the second plurality of orientations can be inserted in the beverage container for a shorter distance than the infuser container having one out of the first plurality of orientations.

4. Apparatus of claim 3, wherein said infuser container is configured to permit an independent rotation of said infuser container and said plurality of extension elements.

5. Apparatus of claim 1, wherein means are provided to prevent said infuser container in said higher stationary position from sliding sideways, said means being selected from a group comprising at least recesses and protrusions surrounding said top opening of said beverage container.

6. Apparatus of claim 1, wherein said beverage container additionally comprises at least an element selected from a group comprising at least: a nozzle or nozzles, a handle or handles, a reinforcing rim member attached to the top opening of the beverage container, a cover attached to the top opening of said beverage container, a stand or support, a lid or lids.

7. Apparatus of claim 1, wherein said infuser container additionally comprises at least an element selected from a group comprising at least: a nozzle or nozzles, a handle or handles, a stand or support, and a lid or lids.

8. Apparatus of claim 1, additionally comprising a lid, said lid being preferably configured to be capable of serving as a tray for said infuser container when said infuser container is detached from said beverage container.

9. Apparatus of claim 1, wherein said infuser container is adapted to be used in combination with a variety of existing vessels serving as beverage containers, and wherein said beverage container is an existing vessel available to a user.
